(19) United States
(12) Patent Application Publication
(10) Pub. No.: US 2026/0177466 A1
(43) Pub. Date: Jun. 25, 2026

(54) MATERIAL TESTING MACHINES WITH REMOVABLE MEMORY DEVICES

(71) Applicant: ILLINOIS TOOL WORKS INC., GLENVIEW, IL (US)

(72) Inventors: John Matthew Mullervy, Natick, MA (US); William Masek, North Attleboro, MA (US); Michael Price, Attleboro, MA (US)

(21) Appl. No.: 19/419,492

(22) Filed: Dec. 15, 2025

Related U.S. Application Data
(60) Provisional application No. 63/736,225, filed on Dec. 19, 2024.

(51) Int. Cl. G01N 3/62; G01N 3/04; G01N 3/06

(52) U.S. Cl. CPC G01N 3/62; G01N 3/04; G01N 3/066; G01N 2203/0204

(57) ABSTRACT

In some examples, a material testing machine stores diagnostic data related to the usage of material testing machine on a removable memory device that is coupled to and/or housed within the material testing machine. In some examples, the stored diagnostic data may be useful if there is some sort of damage or malfunction suffered by the material testing system 100 in the future. In some examples, the material testing machine is also configured to allow for easy removal of the removal memory device so that it can be transported elsewhere (which may be convenient and/or necessary to analyze the diagnostic data). Despite needing to transport the diagnostic data to a remote system for examination and/or analysis, it may still be better to store the diagnostic data within the material testing machine 102 (rather than in some external memory) to ensure the integrity, granularity, and/or availability of the data.

### CROSS REFERENCE TO RELATED APPLICATIONS

This application claims priority to, and the benefit of, U.S. Provisional Ser. No. 63/736,225, filed Dec. 19, 2024, entitled “Material Testing Machines with Removable Memory Devices,” the entire contents of which are hereby incorporated by reference.

### TECHNICAL FIELD

The present disclosure generally relates to material testing machines and, more particularly, to material testing machines with removable memory devices.

### BACKGROUND

Material testing machines are used to test the properties (e.g., tensile/compressive strength) of various material specimens. The particular method of testing (a.k.a. test method) may vary depending on the material specimen, the testing machine, and/or the properties to be tested.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to material testing machines with removable memory devices, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIGS. 1a-1d show different states of an access panel of a material testing machine of a material testing system, progressing from a closed state where a removable memory device is connected and concealed, to an open state where the removable memory device is exposed and removed, in accordance with aspects of this disclosure.

FIG. 2 shows an expanded view of the access panel and removable memory device shown in FIG. 1d, where the removable memory device is exposed and removed from control circuitry of the material testing machine, in accordance with aspects of this disclosure.

FIG. 3 is a flowchart illustrating an example storage process of the material testing machine of FIGS. 1a-1d, in accordance with aspects of this disclosure.

The figures are not necessarily to scale. Where appropriate, the same or similar reference numerals are used in the figures to refer to similar or identical elements. For example, reference numerals utilizing lettering (e.g., grip 118a, grip 118b) refer to instances of the same reference numeral that does not have the lettering (e.g., grips 118).

### DETAILED DESCRIPTION

Disclosed herein are examples of material testing machines with removable memory devices. In some examples, a removable memory device may be housed within a material testing machine, and/or used to store diagnostic information related to the usage of the material testing machine (e.g., with respect to tests conducted, maintenance events, configurations, errors, etc.). In such examples, the removable memory may serve as a sort of “black box” (e.g., similar to an airplane black box), that can be removed from the material testing machine in case of damage to and/or malfunction of the machine, and then analyzed (e.g., by service technicians and/or via a separate system) to determine the cause(s) and/or reason(s) for the damage and/or malfunction.

While some material testing machines may have non-removable internal memory, the utility of storing diagnostic information in such memory is limited, as the material testing machine itself may be ill equipped for review of the diagnostic information. Additionally, memory internal to material testing machines tends to be volatile memory that is transitory and/or non-persistent, and thus unsuitable for storing diagnostic information for any length of time. To the extent there is non-volatile and/or non-transitory internal memory, the memory is often very small and/or only used to store basic identifying information of the testing machine. Thus, it may be useful to have additional internal memory that can both augment existing internal memory, and that can be removed and transported to a different system for review and/or analysis of the stored diagnostic information.

Though some material testing systems may use external memory to store diagnostic information, this may also be less than ideal as there is a non-trivial risk that the external memory will become lost and/or separated from the material testing machine. For example, the external memory may be computer memory that is part of an external computing system, and the computing system may be replaced and/or upgraded, along with the external memory. Also, there is a non-trivial risk that intentional and/or unintentional changes to the computing system might alter, corrupt, and/or otherwise render the diagnostic data stored on the external memory unusable (e.g., due to hacking, malware, software updates, etc.). Additionally, some detail and/or granularity of the data captured by internal sensors of the material testing machine may be lost when transmitting the data to an external memory/computing system (e.g., due to bandwidth limitations of connecting cables). These issues may be mitigated by allowing the material testing machine to accommodate an internal removable memory device.

Some examples of the present disclosure relate to a material testing machine, comprising: a testing frame comprising a bottom base connected with a top plate via a guide rail; a movable crosshead configured to move along the guide rail; a fixture attached to the movable crosshead, the fixture being configured to hold or support a test sample; a test sensor configured to measure a test force applied to the test sample during a test, the test sensor being configured to output test sensor data representative of the test force; a memory connector enclosed within the testing frame; a removable memory device removably connected with the memory connector, the removable memory device being enclosed within the testing frame when the removable memory device is connected with the memory connector; and control circuitry enclosed within the testing frame, the control circuitry being in electrical communication with the memory connector, and the control circuitry being configured to store a timestamped record of the test data in the removable memory device when the removable memory device is removably connected with the memory connector.

In some examples, the removable memory device comprises non-transitory and non-volatile memory circuitry. In some examples, the material testing machine further comprises a drive system configured to induce movement of the movable crosshead, the control circuitry being configured to control the drive system. In some examples, the control circuitry is configured to disable operation of the material testing machine when the removable memory device is disconnected from the memory connector.

In some examples, the timestamped record comprises a first timestamped record, the control circuitry being configured to store in the removable memory device a second timestamped record of a start test signal sent to the material testing machine by a computing device in communication with the material testing machine. In some examples, the computing device is further configured to send log data to the material testing machine, the control circuitry being configured to store in the removable memory device a third timestamped record of log data sent to the material testing system by the computing device. In some examples, the timestamped record comprises a first timestamped record, the material testing machine further comprising: a machine sensor in communication with the control circuitry, the machine sensor being configured to capture or output machine sensor data indicative of a machine characteristic of the material testing machine, the control circuitry being further configured to store in the removable memory device a second timestamped record of the machine sensor data.

Some examples of the present disclosure relate to a material testing system, comprising: a material testing machine, comprising: a testing frame comprising a bottom base connected with a top plate via a guide rail, a movable crosshead configured to move along the guide rail, a fixture attached to the movable crosshead, the fixture being configured to hold or support a test sample, a test sensor configured to measure a test force applied to the test sample during a test, the test sensor being configured to output test sensor data representative of the test force, a memory connector enclosed within the testing frame, a removable memory device removably connected with the memory connector, the removable memory device being enclosed within the testing frame when the removable memory device is connected with the memory connector, and control circuitry enclosed within the testing frame, the control circuitry being in electrical communication with the memory connector, and the control circuitry being configured to store a timestamped record of the test data in the removable memory device when the removable memory device is removably connected with the memory connector.

In some examples, the removable memory device comprises non-transitory and non-volatile memory circuitry. In some examples, the material testing machine further comprises a drive system configured to induce movement of the movable crosshead, the control circuitry being configured to control the drive system. In some examples, the control circuitry is configured to disable operation of the material testing machine when the removable memory device is disconnected from the memory connector.

In some examples, the timestamped record comprises a first timestamped record, the system further comprising a computing device in communication with the material testing machine, the computing device being configured to send a start test signal to the material testing machine in response to receiving a start test input, and the control circuitry being configured to store in the removable memory device a second timestamped record of the start test signal. In some examples, the computing device is further configured to send log data to the material testing machine, the control circuitry being configured to store in the removable memory device a third timestamped record of the log data. In some examples, the timestamped record comprises a first timestamped record, the material testing machine further comprising: a machine sensor in communication with the control circuitry, the machine sensor being configured to measure a machine characteristic of the material testing machine and output machine sensor data indicative of the machine characteristic, the control circuitry being further configured to store in the removable memory device a second timestamped record of the machine sensor data.

Some examples of the present disclosure relate to a method, comprising: measuring, via a test sensor a material testing machine, a test force applied to a test sample during a test, the material testing machine comprising: a testing frame comprising a bottom base connected with a top plate via a guide rail, a movable crosshead configured to move along the guide rail, a fixture attached to the movable crosshead, the fixture being configured to hold or support the test sample, the test sensor, a memory connector enclosed within the testing frame, a removable memory device removably connected with the memory connector, the removable memory device being enclosed within the testing frame when the removable memory device is connected with the memory connector, and control circuitry enclosed within the testing frame, the control circuitry being in electrical communication with the memory connector; outputting, via the test sensor of the material testing machine, test sensor data representative of the test force; and storing a timestamped record of the test data in the removable memory device, via the control circuitry, when the removable memory device is removably connected with the memory connector.

In some examples, the material testing machine further comprises a drive system, the method further comprising controlling the drive system, via the control circuitry, to induce movement of the movable crosshead during the test. In some examples, the method further comprises disabling operation of the material testing machine, via the control circuitry, when the removable memory device is disconnected from the memory connector. In some examples, the timestamped record comprises a first timestamped record, the method further comprising: receiving, at the material testing machine, a start test signal sent by a computing device in communication with the material testing machine in response to the computing device receiving a start test input; and storing in the removable memory device, via the control circuitry, a second timestamped record of the start test signal.

In some examples, the method further comprises: receiving, at the material testing machine, log data sent by the computing device; and storing in the removable memory device, via the control circuitry, a third timestamped record of the log data. In some examples, the timestamped record comprises a first timestamped record, and the material testing machine further comprises a machine sensor in communication with the control circuitry, the method further comprising: measuring a machine characteristic of the material testing machine via the machine sensor; outputting, via the machine sensor, machine sensor data indicative of the machine characteristic; and storing in the removable memory device, via the control circuitry, a second timestamped record of the machine sensor data.

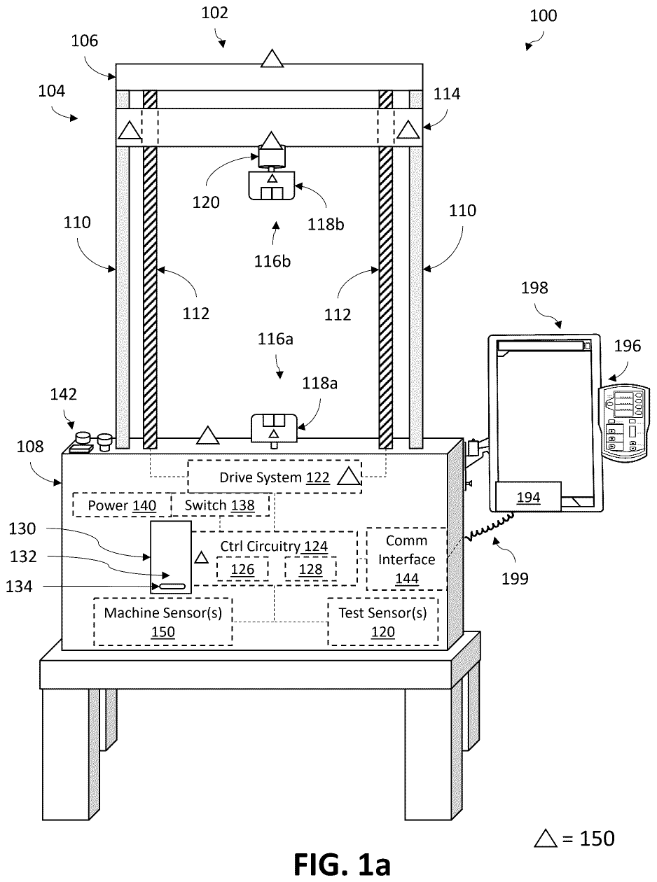

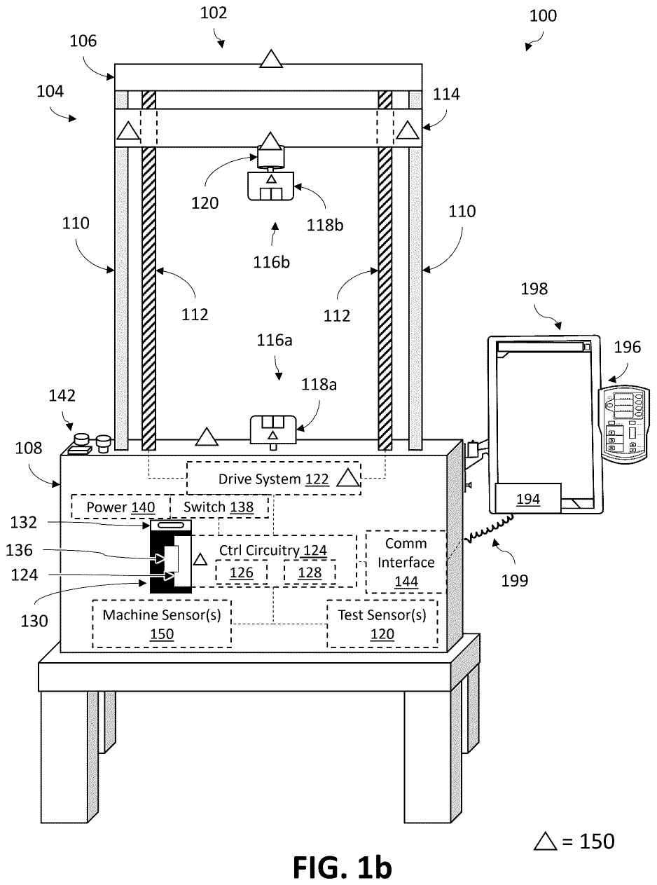

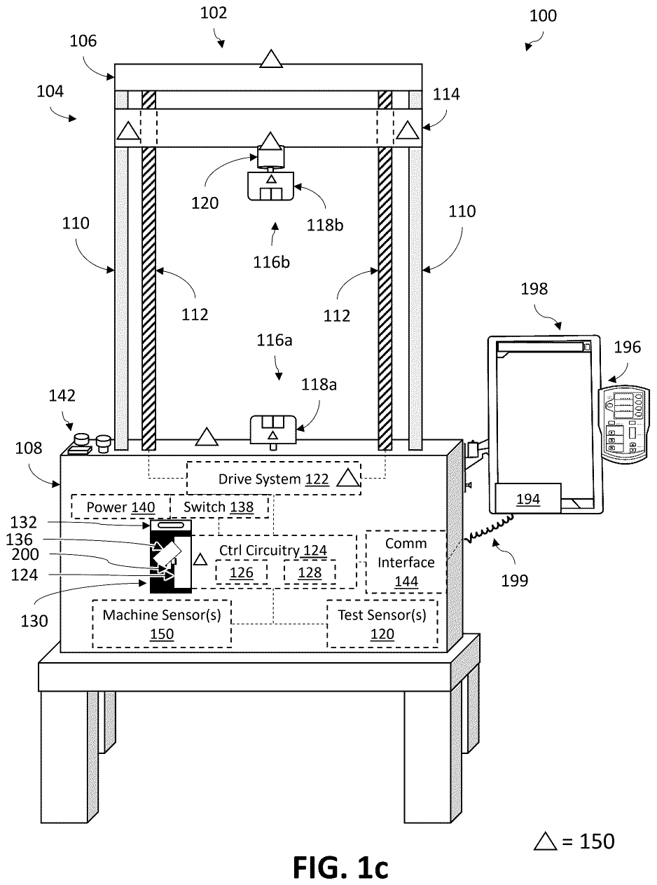

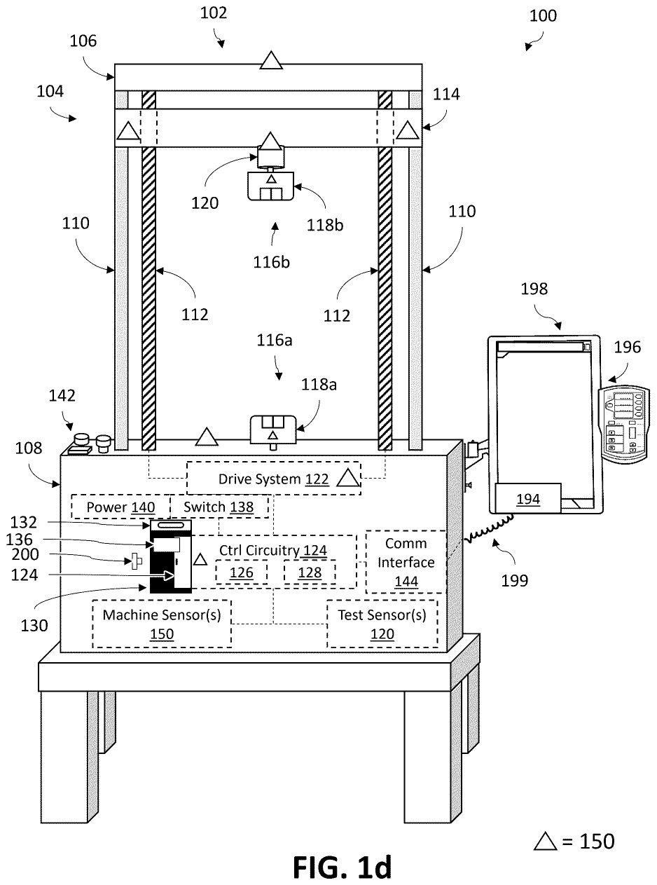

FIGS. 1a-1d shows an example material testing system 100. As shown, the material testing system 100 includes a material testing machine 102 (also known as a universal testing machine), and a computing device 198 connected to the material testing machine 102 through cable 199. While shown as being physically connected via the cable 199, in some examples, the connections between the material testing machine 102 and computing device 198 may be wireless rather than wired.

In some examples, the material testing machine 102 may be configured for static mechanical testing. For example, the material testing machine 102 may be configured for compression strength testing, tension strength testing, shear strength testing, bend strength testing, deflection strength testing, tearing strength testing, peel strength testing (e.g., strength of an adhesive bond), torsional strength testing, and/or any other compressive and/or tensile testing. Additionally or alternatively, the material testing machine 102 may be configured to perform dynamic testing.

In the example of FIGS. 1a-1d, the material testing machine 102 includes a frame 104. In some examples, the frame 104 provides rigid structural support for the other components of the material testing machine 102.

As shown, the frame 104 comprises a top plate 106 and a bottom base 108 connected by two guide rails 110 and two drive shafts 112. While two guide rails 110 and two drive shafts 112 are shown, in some examples, more or fewer guide rails 110 and/or drive shafts 112 may be used. In some examples, the drive shafts 112 are connected to the top plate 102 and bottom base 108 via bearings that allow the drive shafts 112 to rotate. In some examples, the guide rail(s) 110 and/or drive shaft(s) 112 of the material testing machine 102 are housed and/or enclosed within columns of the frame 104.

In the example of FIGS. 1a-1d, a movable crosshead 114 extends between the guide rails 110 and drive shafts 112 of the material testing machine 102. As shown, the movable crosshead 114 is connected to the guide rails 110 and drive shafts 112, and/or configured to move toward and/or away from the bottom base 108 of the material testing machine 102 through (e.g., motorized) actuation of the drive shaft(s) 112. In some examples, each crosshead 114 includes guide channels through which the guide rails 110 extend, such that movement of the crosshead 114 is guided along the guide rails 110. While one movable crosshead 114 is shown in the example of FIG. 1, in some examples, the material testing machine 102 may have multiple movable crossheads 114, and/or other movable members.

In the example of FIGS. 1a-1d, a fixture 116 is attached to the bottom base 108 of the frame 104, as well as to the movable crosshead 114. As shown, the lower fixture 116a includes a grip 118a, while the upper fixture 116b includes both a test sensor 120 and a grip 118b. While one test sensor 120 and two grips 118 are shown in the example of FIG. 1, in some examples, the testing machine 102 may include more or fewer test sensors 120 and/or grips 118.

In some examples, the grips 118 are used to hold test specimens. In some examples, different grips may be used to hold different types of test specimens. In some examples, the grip 118a and/or grip 118b may be configured as a rope holder, bolt holder, wedge grip, side acting grip, manual grip, roller grip, capstan grip, and/or syringe holder. In some examples, one or both of the grips 118 may be replaced by a compression platen configured to compress test specimens.

In the example of FIGS. 1a-1d, the test sensor 120 is connected to the upper grip 118b, such that the test sensor 120 can measure forces acting on the grip 118 (and/or forces acting on the specimen, crosshead 114, etc.). In some examples, the test sensor 120 measures, detects, captures, and/or outputs test sensor data representative of the force(s) acting on the grip 118 (and/or specimen, crosshead 114, etc.). In some examples, the test sensor 120 is a load cell. In some examples, the test sensor 120 may be some other type of sensor.

In some examples, each crosshead 114 further includes drive shaft attachments that couple the crosshead 114 to the drive shafts 112. In some examples, the drive shaft attachments may be fixedly secured to the crossheads 114.

In some examples, the drive shaft attachments may comprise screw threaded nuts, ball screw assemblies, and/or ball bearings that engage with screw threads of the drive shafts 112. In some examples, the drive shaft attachments may be moved up and/or down the screw threads of the drive shafts 112 when the drive shafts 112 are actuated (e.g., rotated), thereby moving the crossheads 114 up and/or down the guide rails 110. In some examples, the drive shaft attachments may alternatively, or additionally, use hydraulic energy to move the crossheads 114 up and/or down the guide rails 110 between the top plate 106 and the bottom base 108 when actuated.

In the example of FIGS. 1a-1d, the example improved material testing machine 102 further includes a drive system 122. As shown, the drive system 122 is housed and/or enclosed within the base 108 of the material testing machine 102. The drive system 122 is further shown connected to both drive shafts 112. In some examples, the drive system 122 is configured to actuate (e.g., rotate) both drive shafts 112 and/or the crosshead 114.

In some examples, the drive system 122 of the material testing machine 102 includes one or more actuators connected with, and/or configured to actuate, the one or more drive shafts 112. In some examples, the actuators are used to provide force to, and/or induce motion of, the drive shafts 112. In some examples, the actuators may include electric motors, pulley systems, pneumatic actuators, hydraulic actuators, hydraulic pumps, piezoelectric actuators, relays, and/or switches.

In the example of FIGS. 1a-1d, the material testing system 100 additionally includes machine control circuitry 124. In some examples, the machine control circuitry 124 comprises one or more (e.g., printed) circuit boards. As shown, the machine control circuitry 124 is housed and/or enclosed within the base 108 of the material testing machine 102. In some examples, the machine control circuitry 124 is configured to drive and/or otherwise control operation of the material testing machine 102 (e.g., via the drive system 122).

In the example of FIGS. 1a-1d, the machine control circuitry 124 includes machine processing circuitry 126. In some examples, the machine processing circuitry 126 includes one or more processors. In some examples, the machine processing circuitry 126 includes clock circuitry that keeps track of and/or stores/updates the current date and/or time (e.g., thereby facilitating the storing of timestamped records).

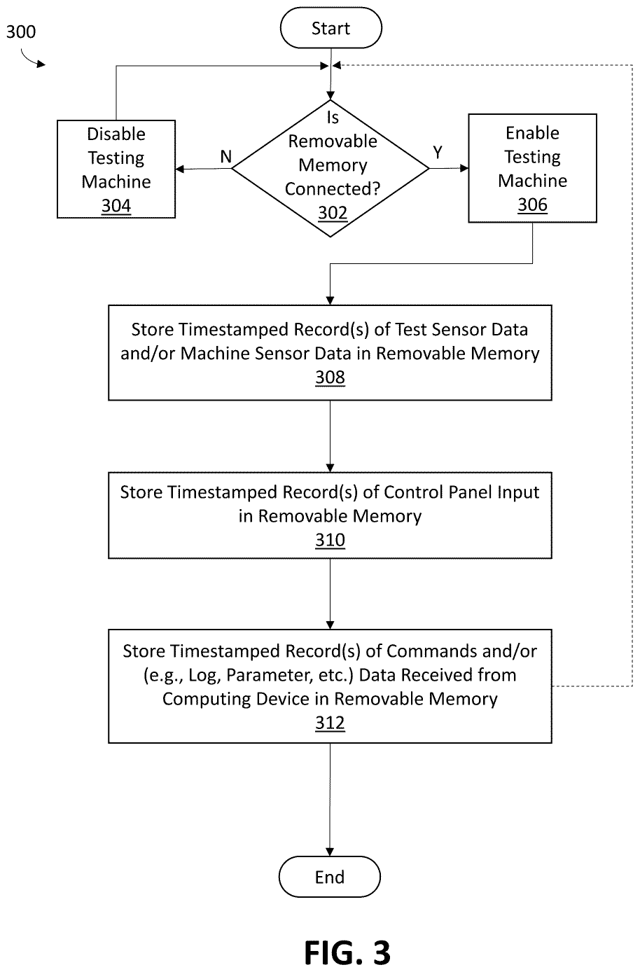

In the example of FIGS. 1a-1d, the machine control circuitry 124 includes some integrated (e.g., non-removable) machine memory circuitry 128. In some examples, the integrated memory circuitry 128 comprises at least some permanent, non-transitory, and/or non-volatile memory circuitry 128. In some examples, the integrated machine memory circuitry 128 is relatively small, and stores identifying information of the material testing machine 102. In some examples, the integrated machine memory circuitry 128 stores a current date and/or time (e.g., thereby facilitating the storing of timestamped records). In some examples, the integrated machine memory circuitry 128 stores machine readable instructions, such as, for example, to implement a machine storage process 300, further described below with respect to FIG. 3.

In the example of FIGS. 1a-1d, the machine control circuitry 124 is shown as being enclosed and/or housed within the bottom base 108 of the material testing machine 102. In the example of FIG. 1a, the machine control circuitry 124 is hidden from outside view by the bottom base 108. However, in the examples of FIGS. 1b-1d, at least a portion of the machine control circuitry 124 is visible and/or accessible through an access panel 130 of the bottom base 108.

In the example of FIG. 1a, access to the internal components of the material testing machine 102 via the access panel 130 is sealed and/or closed off by the access panel door 132. In some examples, the access panel door 132 may include a lock, latch, clasp, and/or other mechanism to secure the access panel door 132 in the closed position and prevent and/or reduce inadvertent and/or unauthorized opening of the access panel door 132.

In the examples of FIG. 1a-1d, the access panel door 132 includes a handle 134 that an authorized user may use to open the access panel door 132 (e.g., after unlocking the access panel door 132). In some examples, access panel door 132 is moved to open the access panel 130, such as, for example, by sliding the access panel door 132 upwards (e.g., towards the top plate 106). While shown as sliding upwards in the examples of FIGS. 1a-1d, in some examples, the access panel door 132 may alternatively, or additionally, be opened by sliding downwards, swinging outwards (e.g., via a hinge), and/or opening some other way. While shown as being movable while still attached to the bottom base 108, in some examples, the access panel door 132 may instead need to be entirely removed from the bottom base 108 in order to open access the access panel 130 (e.g., by removing fasteners holding the access panel door 132 in place).

FIGS. 1b-1d show example views of the material testing machine 102 with the access panel door 132 opened. As shown, when the access panel door 132 is opened, at least part of the machine control circuitry 124 is accessible through the access panel 130.

In the example of FIGS. 1b-1d, a protective cover 136 is also shown as being accessible through the access panel 130 when the access panel door 132 is opened. The protective cover 136 is shown attached to (e.g., part of the circuit board of) the machine control circuitry 124 in the example of FIGS. 1b-1d. In some examples, the protective cover 136 may alternatively, or additionally, be attached some other structure within material testing machine 102 (e.g.,). In some examples, the protective cover 136 is movable with respect to, and/or removable from, the machine control circuitry 124.

FIGS. 1c-1d show examples of the protective cover 136 moved about a hinged connection to an open position where a removable memory device 200 is revealed, exposed, and/or accessible via the access panel 130. In some examples, the removable memory device 200 is small, lightweight, and/or easily transportable. In some examples, the removable memory device 200 may be a universal serial bus (USB) thumb drive, jump drive, and/or memory stick. In some examples, the removable memory device 200 may be a secure digital (SD) card.

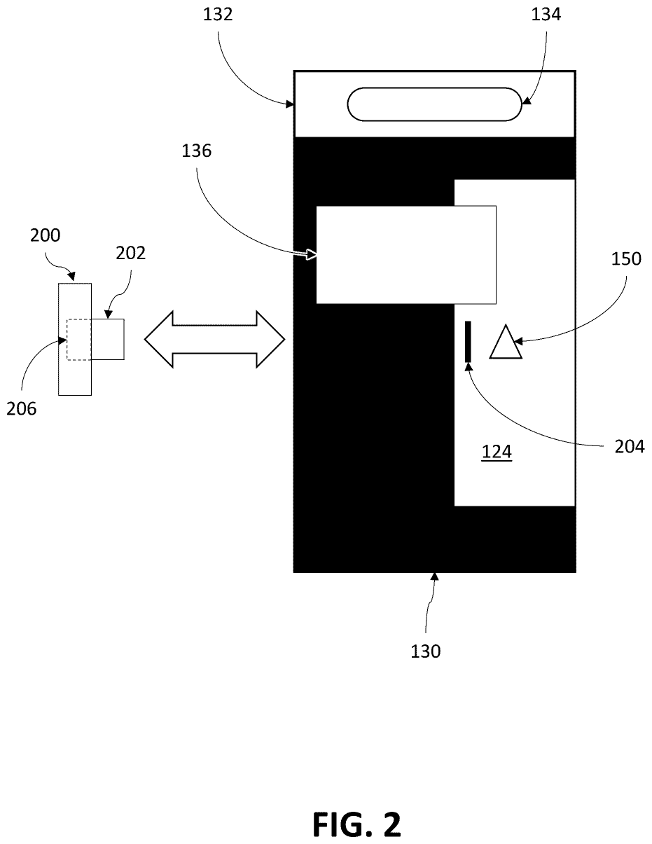

In the example of FIG. 1c, the removable memory device 200 is still connected, coupled, and/or in electrical communication with the machine control circuitry 124. In particular, an electrical connector 202 (e.g., plug, protrusion, etc.) of the removable memory device 200 is electrically connected with a complementary electrical connector 204 (e.g., socket, slot, etc.) of the machine control circuitry 124 (see, e.g., FIG. 2). In some examples, the electrical connector 202 of the removable memory device 200 includes one or more electrical conductors that make electrical contact with one or more complementary conductors of the complementary electrical connector 204 of the machine control circuitry 124 when the removable memory device 200 is electrically connected with a complementary electrical connector 204.

In the example of FIG. 2, the removable memory device 200 includes memory circuitry 206 in electrical communication with (e.g., the electrical conductors of) the electrical connector 202. In some examples, when the removable memory device 200 is electrically connected to the machine control circuitry 124, the machine control circuitry 124 stores timestamped records of diagnostic information related to the usage of the material testing machine 102 in the memory circuitry 206 of the removable memory device 200. In this way, the removable memory device 200 can keep a data record relating to the usage of the material testing machine 102 that can be later examined and/or analyzed (e.g., by service technicians and/or via a separate system) if the material testing machine 102 suffers some sort of damage and/or malfunction.

In some examples, the connection between the electrical connector 202 of the removable memory device 200 and the complementary electrical connector 204 of the machine control circuitry 124 is a toolless connection. In some examples, the toolless connection can be engaged and/or disengaged without the need for and/or use of tools, and/or without damage to the removable memory device 200 or the machine control circuitry 124. In some examples, this easily engaged/disengaged configuration allows the removable memory device 200 to be easily removed from the machine control circuitry 124 and/or material testing machine 102.

In some examples, easy removal of the removable memory device 200 may allow for the removable memory device 200 to be removed from the material testing machine 102 and/or transported elsewhere. In some examples, it may be necessary to remove the removable memory device 200 from the material testing machine 102 and/or transport the removable memory device 200 elsewhere (e.g., to the computing device 198 or a remote computing system) to view, examine, and/or analyze the records stored on the removable memory device 200. This is because the material testing machine 102 itself may be ill equipped to facilitate viewing, examination, and/or analysis of the records stored on the removable memory device 200 (e.g., by service technicians).

Though the removable memory device 200 may be easily removed once the protective cover 136 is disengaged, in some examples, while the protective cover 136 is in place over the removable memory device 200 (e.g., as shown in FIG. 1b), the removable memory device 200 remains securely connected to the machine control circuitry 124 of the material testing machine 102. In some examples, the protective cover 136 serves to both protect the removable memory device 200 from damage and to keep the removable memory device 200 securely connected to the machine control circuitry 124. In some examples, one or more fasteners may alternatively, or additionally, be used to secure the connection between the removable memory device 200 and the machine control circuitry 124. In some examples, one or more fasteners may be used to secure the protective cover 136 to the machine control circuitry 124.

In some examples, it can be important to maintain the connection between the removable memory device 200 and the machine control circuitry 124, lest the material testing machine 102 no longer be able to record data on the removable memory device 200. In some examples, the machine control circuitry 124 emphasizes this importance by disabling the material testing machine 102 if and/or when the removable memory device 200 becomes disconnected from the machine control circuitry 124. In some examples, the material testing machine 102 uses one or more machine sensors 150 to detect if/when the removable memory device 200 becomes disconnected from the machine control circuitry 124.

In the example of FIG. 2, a machine sensor 150 is positioned in/on the machine control circuitry 124 proximate the complementary electrical connector 204. In some examples, the machine sensor 150 is configured to measure, detect, capture, and/or output sensor data indicative of (and/or that can be used to determine) whether the removable memory device 200 is connected to the machine control circuitry 124.

For example, the machine sensor 150 might detect electrical current through, and/or electrical voltage across, a circuit that is only completed when the removable memory device 200 is in electrical connection with the machine control circuitry 124. As another example, where the complementary electrical connector 204 comprises a slot/socket, the machine sensor 150 may detect a light that is emitted across an air gap (e.g., at the end) of the slot/socket when the removable memory device 200 is not completely inserted into the slot/socket, and not detect the light (e.g., due to the obstruction of the removable memory device 200) when the removable memory device 200 is completely inserted into the slot/socket. Other detection methods may also be used.

In some examples, the machine control circuitry 124 may determine, based on the sensor data measured, detected, captured, and/or output by the machine sensor(s) 150, whether the removable memory device 200 is mechanically and/or electrically connected to the machine control circuitry 124. In some examples, the machine control circuitry 124 will disable the material testing machine 102 in response to determining that the removable memory device 200 is not mechanically and/or electrically connected to the machine control circuitry 124.

In the examples of FIGS. 1a-1d, the material testing system 100 includes a controllable circuit element 138 that may be used, in some examples, to disable the material testing machine 102 if the removable memory device 200 is not mechanically and/or electrically connected to the machine control circuitry 124. In some examples, the controllable circuit element 138 is an electrical switch, contactor, transistor, and/or other controllable circuit element. As shown, the controllable circuit element 138 is connected with the machine control circuitry 124, which may, in some examples, control operation of the controllable circuit element 138 (e.g., via one or more electrical signals).

In the examples of FIGS. 1a-1d, the controllable circuit element 138 is shown connected between a power supply 140 of the material testing machine 102 and the drive system 122 of the material testing machine 102. In some examples, to disable the material testing machine 102, the machine control circuitry 124 controls the controllable circuit element 138 to open and/or to otherwise disconnect an electrical circuit connecting the power supply 140 to the drive system 122. With the power supply 140 disconnected from the drive system 122, there is no electrical power available for the drive system 122 to use to drive and/or move the crosshead 114 (e.g., to conduct a test). In some examples, to enable the material testing machine 102, the machine control circuitry 124 controls the controllable circuit element 138 to close and/or connect the electrical circuit connecting the power supply 140 to the drive system 122, such that there is some electrical power available for the drive system 122 to use to drive and/or move the crosshead 114 (e.g., to conduct a test).

Though not shown, in some examples, the power supply 140 may also be in electrical communication with, and/or provide electrical power to, other components of the material testing machine 102 (e.g., machine control circuitry 124, test sensor 120, etc.). While only one controllable circuit element 138 is shown in the examples of FIGS. 1a-1d, in some examples, several controllable circuit elements 138 may be used and/or controlled. Though shown in a particular position, in some examples, the controllable circuit element 138 may be otherwise positioned, such as to control power distribution to other components of the material testing machine 102. Though the controllable circuit element 138 is one way in which the machine control circuitry 124 might enable/disable the material testing machine 102, in some examples, the machine control circuitry 124 may use a different method of enabling/disabling the material testing machine 102 (e.g., using one or more enable/disable signals, and/or obeying/ignoring start test commands).

In the example of FIGS. 1a-1d, other machine sensors 150 are also positioned in/on the material testing machine 102 at various places. In some examples, the machine sensors 150 may measure, detect, capture, and/or output a sensor data indicative of (and/or that can be used to determine) other operational aspects of the material testing machine 102.

For example, a machine sensor 150 positioned in/on the drive system 122 may be configured to measure, detect, capture, and/or output sensor data indicative of (and/or that can be used to determine) a voltage, current, and/or temperature of a motor of the drive system 122. As another example, a machine sensor 150 positioned in/on the drive system 122 may be configured to measure, detect, capture, and/or output sensor data indicative of (and/or that can be used to determine) hydraulic pressure, flow rate, volume, etc. of the drive system 122.

As another example, a machine sensor 150 positioned in/on the bottom base 108 may measure, detect, capture, and/or output sensor data indicative of (and/or that can be used to determine) whether the bottom base 108 is level, and/or an angle of the bottom base 108 relative to the direction of the Earth's gravity. As another example, a machine sensor 150 positioned in/on the material testing machine 102 may measure, detect, capture, and/or output sensor data indicative of (and/or that can be used to determine) a temperature, humidity, air content, etc. of surrounding environment.

As another example, a machine sensor 150 positioned in/on a fixture 116 and/or grip 118 of the material testing machine 102 may measure, detect, capture, and/or output sensor data indicative of (and/or that can be used to determine) a pneumatic and/or hydraulic pressure/force used to operate and/or actuate the fixture 116 and/or grip 118. As another example, a machine sensor 150 positioned in/on and/or proximate the test sensor 120 may measure, detect, and/or capture sensor data indicative of (and/or that can be used to determine) an impedance, noise, and/or signal to noise ratio of the test sensor 120 and/or a sensor output signal of the test sensor 120. As another example, a machine sensor 150 positioned in/on and/or proximate the crosshead 114 may measure, detect, capture, and/or output sensor data indicative of (and/or that can be used to determine) a distance traveled by the crosshead 114 (e.g., during a particular test, over the lifetime of the material testing machine 102, and/or since some specified date/time).

In some examples, the machine sensor data measured, detected, captured, and/or output by the machine sensor(s) 150 may be valuable (e.g., to a service technician) when later trying to diagnose and/or understand a malfunction and/or damage to the material testing machine. Thus, in some examples, the machine sensor data measured, detected, captured, and/or output by the machine sensor(s) 150 is (e.g., periodically) stored in the removable memory device 200 by the machine control circuitry 124 (e.g., along with the test sensor data).

In some examples, the machine control circuitry 124 additionally, or alternatively, stores in the removable memory device 200 a timestamped record of input received via a control panel 142 of the material testing machine 102. In the example of FIGS. 1a-1d, the material testing machine 102 includes a control panel 142 positioned in/on the bottom base 108. In some examples, the control panel 142 includes one or more input devices (e.g., buttons, switches, slides, knobs, microphones, dials, and/or other electromechanical input devices) and/or output devices (e.g., lights, display screens, speakers, etc.

In some examples, the control panel 142 may be used by an operator to directly control the material testing machine 102. In some examples, the machine control circuitry 124 is in electrical communication with the control panel 142.. In some examples, the machine control circuitry 124 is configured to translate inputs received via the control panel 216 to appropriate (e.g., electrical) signals that may be delivered to the drive system 122 to control the material testing machine 102. Given the impact inputs of the control panel 142 may have in the usage of the material testing machine 102, the material testing machine 102 may store timestamped records of input received via the control panel 142 in the removable memory device 200 (e.g., for future analysis in the event of damage and/or malfunction).

In some examples, the control panel 142 includes only relatively rudimentary inputs and/or output devices. For example, the control panel 142 might only include a power on/off button, a light to indicate whether the material testing machine 102 is on/off, and an emergency stop button. In some examples, the material testing system 100 uses a connected computing device 198 to facilitate more substantive and/or complicated input and/or output.

In some examples, the machine control circuitry 124 additionally, or alternatively, stores a timestamped record of data received from the computing device 198 in the removable memory device 200. For example, the computing device 198 may send one or more commands and/or parameters to the material testing machine 102 that the machine control circuitry 124 uses to control the material testing machine 102 to conduct a test method. In some examples, the machine control circuitry 124 is configured to translate commands and/or parameters received from the computing device 198 to appropriate (e.g., electrical) signals that may be delivered to the drive system 122 and/or power supply 140 (e.g., commanding more or less electrical power be provided to the drive system 122, and/or commanding the drive system 122 to start/stop). Given their impact, timestamped records of the received data may be useful in the future if/when diagnosing the cause(s) and/or reason(s) for damage and/or a malfunction.

In the example of FIGS. 1a-1d, the computing device 198 comprises a tablet computing device (e.g., operating as a testing workstation). While shown as a tablet computing device, in some examples, the computing device 198 may instead comprise a desktop, laptop, and/or other computing device.

In the examples of FIGS. 1a-1d, the computing device 198 has a user interface (UI) 196. In some examples, the UI 196 includes one or more input devices configured to receive inputs from a user, and one or more output devices configured to provide outputs to the user. In some examples, the one or more input devices of the UI 196 may comprise one or more touch screens, mice, keyboards, buttons, switches, slides, knobs, microphones, dials, and/or other input devices. In some examples, the one or more output devices of the UI 196 may comprise one or more display/touch screens, speakers, lights, haptic devices, and/or other output devices.

In some examples, the output device(s) (e.g., a display screen) of the UI 196 may output one or more prompts for a user to setup and/or execute a test method and/or analyze test results of the test method. In some examples, the input device(s) of the UI 196 may receive input from a user, and provide input data representative of the user input to the computing device 198.

In some examples, the computing device 198 includes computer processing circuitry. In some examples, the computer processing circuitry comprises one or more processors. In some examples, the computer processing circuitry is configured to process information received from the UI 196 and/or material testing machine 102.

In some examples, the computing device 198 includes computer memory circuitry connected with the computer processing circuitry. In some examples, the computer memory circuitry comprises machine readable instructions executable by the computer processing circuitry. In some examples, when executed, the machine readable instructions provide outputs to a user (e.g., via the UI 196) prompting the user to setup a test of a material specimen, start and/or perform the test on the material testing machine 102, and/or analyze test results of the test.

In some examples, a user sets up a test of a material specimen by specifying (e.g., using the UI 196) certain parameters of the test, material specimen, and/or test result analysis. In some examples, test parameters may include a date the test will be run, identification information of the test (e.g., number, name, type, description, etc.), target start/end positions of grip(s) 118, target start/end positions of the crosshead 114, target distance/direction moved by crosshead 114, target speed of movement of crosshead 114, expected result(s) of test (e.g., position/type of break, distance moved before break, force applied before break, post-test characteristics of sample, etc.), time(s) when the test sensor(s) 120 should take measurement(s), and/or other information relevant to a particular test method.

In some examples, specimen parameters may include, a date the specimen was manufactured/shipped/packaged, identification information of the specimen (e.g., number, name, description, etc.), pre-test characteristics of the specimen (e.g., measurements/dimensions, material type, weight, color, shape, modulus, ultimate tensile strength, etc.), and/or other information relevant to a particular specimen. In some examples, analysis parameters may include one or more algorithms that may be used to evaluate results of the test method (and/or produce additional test results), one or more test result report format(s), and/or one or more thresholds and/or threshold ranges (e.g., by which test results may be adjudged to determine whether the specimen passed or failed the test).

In some examples, the specimen, test, and/or analysis parameters are used by the computing device 198 when setting up a test, performing the test of the material specimen, and/or analyzing test results of the test of the material specimen. In some examples, some or all of the specimen, test, and/or analysis parameters are saved/stored in computer memory circuitry. In some examples, some or all of the specimen, test, and/or analysis parameters are sent to the material testing machine 102 (e.g., for storage in the removable memory device 200).

In some examples, one or more signals representative of a command to start a test may additionally, or alternatively, be sent to the material testing machine 102 when a test is to be started (e.g., when the UI 196 receives a corresponding start test input). In some examples, the material testing machine 102 may store in the removable memory device 200 a timestamped record of when the one or more start test signals are received.

In the example of FIGS. 1a-1d, the computing device 198 is communicatively and/or electrically connected to the material testing machine 102 through a cable 199. In particular, the cable 199 is shown connecting together a machine communication interface 144 of the material testing system 100 and a complementary computer communication interface 194 of the computing device 198. In some examples, the computing device 198 (and/or computer processing circuitry) is configured to transmit (e.g., test start) commands, test/specimen/analysis parameters, and/or other test data to the material testing machine 102 via the communication connection between the machine communication interface 144 of the material testing system 100 and complementary computer communication interface 194 of the computing device 198.

In some examples, the machine communication interface 144 and/or the computer communication interface 194 comprises a network interface. In some examples, the machine communication interface 144 and/or the computer communication interface 194 includes hardware, firmware, and/or software to enable communication between the machine communication interface 144 and the computer communication interface 194.

In some examples, the machine control circuitry 124 receives information (e.g., commands, parameters, etc.) from the computing device 198 through the computer communication interface 194, and/or sends information (e.g., sensor data from test sensor(s) 120 and/or machine sensor(s) 150) to the computing device 198 through the computer communication interface 194.

In some examples, the computing device 198 additionally keeps timestamped data logs in the computer memory circuitry. For example, the computing device 198 may keep a timestamped log of events, such as, for example, login/logout events, firewall change events, setting change events, message events, service events, calibration events, test (e.g., setup, execution, analysis, etc.) events, sensor measurement events, operating system events, and/or malfunction/error events. In some examples, the computing device 198 additionally keeps a timestamped log of reports corresponding to the events (e.g., setting change reports, service reports, calibration reports, test result reports, etc.). As another example, the computing device may keep a timestamped log of the performance, capacity, usage, etc. of the computer processing circuitry and/or computer memory circuitry.

In some examples, the computing system sends the timestamped data log(s) to the material testing machine 102. In some examples, the material testing machine stores the timestamped data log(s) in the removable memory device 200 (e.g., in case the data logs are later needed and/or useful in analyzing the cause of damage and/or a malfunction).

FIG. 3 is a flow diagram showing an example storage process 300 of the material testing machine 102. In some examples, the storage process 300 is implemented via analog circuitry (e.g., of the machine control circuitry 124). In some examples, the storage process 300 is implemented via machine readable instructions stored in the machine memory circuitry 128 and/or executed by the machine processing circuitry 126.

In the example of FIG. 3, the storage process 300 begins at block 302, where the machine control circuitry 124 determines whether the removable memory device 200 is electrically and/or physically connected to the machine control circuitry 124. In some examples, the determination is based on sensor data measured, detected, captured, and/or output by the test machine sensor(s) 150 of the material testing machine 102, as discussed above. If the machine control circuitry 124 determines the removable memory device 200 is not electrically and/or physically connected to the machine control circuitry 124, the machine control circuitry 124 disables the material testing machine 102 at block 304, as discussed above.

As shown, blocks 302-304 of the storage process 300 repeat until the machine control circuitry 124 determines whether the removable memory device 200 is electrically and/or physically connected to the machine control circuitry 124. Once the machine control circuitry 124 determines the removable memory device 200 is electrically and/or physically connected to the machine control circuitry 124 at block 302, the machine control circuitry 124 enables the material testing machine 102 at block 306, as discussed above.

After block 306, the storage process proceeds to block 308, where the machine control circuitry 124 stores in the removable memory device 200 one or more timestamped records of sensor data measured, detected, captured, and/or output by the test sensor(s) 120 and/or machine sensor(s) 150 of the material testing machine 102, as discussed above. Afterwards, at block 310, the machine control circuitry 124 stores in the removable memory device 200 one or more timestamped records of control input received via the control panel 142 (to the extent any is received), as discussed above. At block 312, the machine control circuitry 124 stores in the removable memory device one or more timestamped records of data received from the computing device 198 (e.g., start test command(s), test/specimen/analysis parameters, data logs, etc.).

In some examples, the machine control circuitry 124 uses the current date and/or time tracked by the clock circuitry and/or stored in the integrated memory circuitry 128 to create the timestamp(s). In some examples where the data is already timestamped (e.g., as with the data logs), an additional timestamp may be included for the received date/time, or the additional timestamp may be omitted. As used herein, a “timestamp” refers to a date and/or time, and when something is “timestamped” that thing includes and/or is associated with the date and/or time of the timestamp.

In some examples, the storage process 300 occurs periodically. In some examples, the storage process occurs in response to received data and/or commands (e.g., from the control panel 142 and/or computing device 198). While shown as ending after block 312, in some examples, the storage process returns to block 302 after block 306.

The disclosed material testing system 100 includes a material testing machine 102 configured to accommodate a removable memory device 200, and store on the removable memory device 200 diagnostic data related to the usage of material testing machine 102. In some examples, the stored data may be useful to future diagnostics and/or analysis (e.g., by service technicians), such as if there is some sort of damage or malfunction suffered by the material testing system 100. In some examples, the material testing machine 102 is also configured to allow for easy removal of the removable memory device 200 so that it can be transported elsewhere (which may be necessary for the diagnostics and/or analysis). Nevertheless, it can be better to store the diagnostic data within the material testing machine 102, rather than in some external memory, to ensure the integrity, granularity, and/or availability of the diagnostic data.

The present methods and/or systems may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit and/or control circuitry may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

As used herein, disable may mean deactivate, incapacitate, and/or make inoperative. As used herein, enable may mean activate and/or make operational.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling

What is claimed is:

1. A material testing machine, comprising:
a testing frame comprising a bottom base connected with a top plate via a guide rail;
a movable crosshead configured to move along the guide rail;
a fixture attached to the movable crosshead, the fixture being configured to hold or support a test sample;
a test sensor configured to measure a test force applied to the test sample during a test, the test sensor being configured to output test sensor data representative of the test force;
a memory connector enclosed within the testing frame;
a removable memory device removably connected with the memory connector, the removable memory device being enclosed within the testing frame when the removable memory device is connected with the memory connector; and
control circuitry enclosed within the testing frame, the control circuitry being in electrical communication with the memory connector, and the control circuitry being configured to store a timestamped record of the test data in the removable memory device when the removable memory device is removably connected with the memory connector.

2. The material testing machine of claim 1, wherein the removable memory device comprises non-transitory and non-volatile memory circuitry.

3. The material testing machine of claim 1, wherein the material testing machine further comprises a drive system configured to induce movement of the movable crosshead, the control circuitry being configured to control the drive system.

4. The material testing machine of claim 1, wherein the control circuitry is configured to disable operation of the material testing machine when the removable memory device is disconnected from the memory connector.

5. The material testing machine of claim 1, wherein the timestamped record comprises a first timestamped record, the control circuitry being configured to store in the removable memory device a second timestamped record of a start test signal sent to the material testing machine by a computing device in communication with the material testing machine.

6. The material testing machine of claim 5, wherein the computing device is further configured to send log data to the material testing machine, the control circuitry being configured to store in the removable memory device a third timestamped record of log data sent to the material testing system by the computing device.

7. The material testing machine of claim 1, wherein the timestamped record comprises a first timestamped record, the material testing machine further comprising:
a machine sensor in communication with the control circuitry, the machine sensor being configured to capture or output machine sensor data indicative of a machine characteristic of the material testing machine,
the control circuitry being further configured to store in the removable memory device a second timestamped record of the machine sensor data.

8. A material testing system, comprising:
a material testing machine, comprising:
a testing frame comprising a bottom base connected with a top plate via a guide rail,
a movable crosshead configured to move along the guide rail,
a fixture attached to the movable crosshead, the fixture being configured to hold or support a test sample,
a test sensor configured to measure a test force applied to the test sample during a test, the test sensor being configured to output test sensor data representative of the test force,
a memory connector enclosed within the testing frame,
a removable memory device removably connected with the memory connector, the removable memory device being enclosed within the testing frame when the removable memory device is connected with the memory connector, and
control circuitry enclosed within the testing frame, the control circuitry being in electrical communication with the memory connector, and the control circuitry being configured to store a timestamped record of the test data in the removable memory device when the removable memory device is removably connected with the memory connector.

9. The system of claim 8, wherein the removable memory device comprises non-transitory and non-volatile memory circuitry.

10. The system of claim 8, wherein the material testing machine further comprises a drive system configured to induce movement of the movable crosshead, the control circuitry being configured to control the drive system.

11. The system of claim 8, wherein the control circuitry is configured to disable operation of the material testing machine when the removable memory device is disconnected from the memory connector.

12. The system of claim 8, wherein the timestamped record comprises a first timestamped record, the system further comprising a computing device in communication with the material testing machine, the computing device being configured to send a start test signal to the material testing machine in response to receiving a start test input, and the control circuitry being configured to store in the removable memory device a second timestamped record of the start test signal.

13. The system of claim 12, wherein the computing device is further configured to send log data to the material testing machine, the control circuitry being configured to store in the removable memory device a third timestamped record of the log data.

14. The system of claim 8, wherein the timestamped record comprises a first timestamped record, the material testing machine further comprising:
a machine sensor in communication with the control circuitry, the machine sensor being configured to measure a machine characteristic of the material testing machine and output machine sensor data indicative of the machine characteristic,
the control circuitry being further configured to store in the removable memory device a second timestamped record of the machine sensor data.

15. A method, comprising:
measuring, via a test sensor a material testing machine, a test force applied to a test sample during a test, the material testing machine comprising:
a testing frame comprising a bottom base connected with a top plate via a guide rail,
a movable crosshead configured to move along the guide rail,
a fixture attached to the movable crosshead, the fixture being configured to hold or support the test sample,
the test sensor,
a memory connector enclosed within the testing frame,
a removable memory device removably connected with the memory connector, the removable memory device being enclosed within the testing frame when the removable memory device is connected with the memory connector, and
control circuitry enclosed within the testing frame, the control circuitry being in electrical communication with the memory connector;
outputting, via the test sensor of the material testing machine, test sensor data representative of the test force; and
storing a timestamped record of the test data in the removable memory device, via the control circuitry, when the removable memory device is removably connected with the memory connector.

16. The method of claim 15, wherein the material testing machine further comprises a drive system, the method further comprising controlling the drive system, via the control circuitry, to induce movement of the movable crosshead during the test.

17. The method of claim 15, further comprising disabling operation of the material testing machine, via the control circuitry, when the removable memory device is disconnected from the memory connector.

18. The method of claim 15, wherein the timestamped record comprises a first timestamped record, the method further comprising:
receiving, at the material testing machine, a start test signal sent by a computing device in communication with the material testing machine in response to the computing device receiving a start test input; and
storing in the removable memory device, via the control circuitry, a second timestamped record of the start test signal.

19. The method of claim 18, further comprising:
receiving, at the material testing machine, log data sent by the computing device; and
storing in the removable memory device, via the control circuitry, a third timestamped record of the log data.

20. The method of claim 15, wherein the timestamped record comprises a first timestamped record, and the material testing machine further comprises a machine sensor in communication with the control circuitry, the method further comprising:
measuring a machine characteristic of the material testing machine via the machine sensor;
outputting, via the machine sensor, machine sensor data indicative of the machine characteristic; and
storing in the removable memory device, via the control circuitry, a second timestamped record of the machine sensor data.
